(19) United States
(12) Patent Application Publication
(10) Pub. No.: US 2005/0167547 A1
(43) Pub. Date: Aug. 4, 2005

(54) Magnetized mounting bracket

(76) Inventor: Robin S. McLellan, Clearwater (CA)

Correspondence Address: Douglas N. Larson;Squire, Sanders & Dempsey, L.L.P., 14th Floor, 801 S. Figueroa Street, Los Angeles, CA, 90017, US

(21) Appl. No.: 10/770,900

(22) Filed: Feb. 2, 2004

(51) Int. Cl. F16L 3/08; A47G 1/17

(52) U.S. Cl. 248/74.4; 248/206.5

(57) ABSTRACT

An apparatus for mounting an object to a ferromagnetic surface comprising an upper support portion adapted to retain the object with a lower magnetic base to the support portion that is attractable to the ferromagnetic surface. A friction layer below the magnetic base separates the magnetic base from direct contact with the ferromagnetic surface whereby the magnetic base acts to releasably retain the support portion on the ferromagnetic surface and the friction layer acts to prevent slippage and provides cushioning. The mounting bracket is particularly suited to anchoring hoses, lines or cables to heavy equipment. The mounting bracket also useful for mounting equipment such as fire extinguishers or other safety equipment to a mounting location in a vehicle. Vehicle emergency lights or brake lights attached to the mounting bracket are readily installable on the exterior of a vehicle at any desired location and removable without damaging the vehicle finish.

### FIELD OF THE INVENTION

This invention relates to a mounting bracket for holding an article in fixed relationship to a surface. In particular, the mounting bracket of the present invention relies on magnetic force to hold an article to a ferromagnetic surface.

### BACKGROUND OF THE INVENTION

Mounting brackets for permanently or releasably securing an article to a surface are well known and find application in all types of environments. In machines of all types, mounting brackets are used to retain conduit in place to adjacent the machine or a component thereof. For example, conduits in the form of rigid lines or flexible hoses used to transport lubricants, coolants, air, hydraulic fluid or the like between different parts of the machine, are often held in position by mounting brackets. In heavy equipment, such as back hoes or the like, flexible hydraulic hoses to control grasping, cutting or digging tools, are held in position at specific locations by mounting bracket incorporating a clamping unit that holds and organizes the hydraulic hoses to permit flexing of the hoses during movement of the tools while preventing pinching or crimping of the lines. These brackets and clamping units are rigidly retained in position by threaded fasteners or welding at spaced intervals along the hydraulic hoses as the hoses extend from control levers in the cabin to the tool to be controlled. Because the mounting brackets are fixed in place, there is the possibility that hydraulic hoses that snag or catch on debris during operation of the heavy equipment will tear at the clamping location. Rigidly fixed mounting brackets are also subject to collision with objects during operation of the machine which may damage the bracket and make disassembly difficult. If a mounting bracket does break off from its anchoring location, re-welding is often required to complete repairs.

### SUMMARY OF THE INVENTION

To address these drawbacks of the prior art, we have developed an improved magnetized mounting bracket which relies on magnets rather than welding or fasteners to anchor an object, particularly a conduit or hose, adjacent a surface.

Accordingly, the present invention provides an apparatus for mounting an object to a ferromagnetic surface comprising:
(a) an upper support portion adapted to retain the object;
(b) a lower magnetic base to the support portion, the base being attractable to the ferromagnetic surface; and
(c) a friction layer below the magnetic base to separate the magnetic base from direct contact with the ferromagnetic surface whereby the magnetic base acts to releasably retain the support portion on the ferromagnetic surface and the friction layer acts to prevent slippage.

In a further aspect, the present invention provides an apparatus for attaching an object to a ferromagnetic surface comprising:
(a) a friction surface adapted to contact the ferromagnetic surface;
(b) a magnetic base adapted to be secured to the ferromagnetic surface at the friction surface; and
(c) an object holding device extending from the magnetic base.

The use of magnets to anchor the mounting bracket of the present invention to a surface avoids the disadvantages of alternative mounting schemes such as threaded fasteners or welding. The magnets allow for a breakaway connection between the mounting bracket and the anchor surface. For example, when used with heavy machines to retain conduits, in the event that the hoses or the bracket catch on debris, if the dislodging force exceeds the magnetic clamping force, the mounting bracket of the present invention will breakaway from the anchor surface to prevent ripping of the hydraulic hoses. The magnets allow for quick and efficient reconnection to the anchor surface. Re-positioning of the mounting bracket is also readily accomplished by prying up the bracket using a force greater than the magnetic force. The magnets eliminate welding thereby avoiding the fire hazard associated with welding activities in the field. Installation time for the mounting bracket is virtually eliminated.

Different anchoring arrangements for attaching an object to the mounting bracket are possible to accommodate a wide variety of objects to be retained. For example, threaded fasteners, slots, releasable clamping units and the like can be used with the mounting bracket of the present invention to reliably hold an object.

### BRIEF DESCRIPTION OF THE DRAWINGS

Aspects of the present invention are illustrated, merely by way of example, in the accompanying drawings in which:

FIG. 1 is a perspective view of a first embodiment of the mounting bracket apparatus of the present invention;

FIG. 2 is an exploded view of the first embodiment showing the component parts;

FIG. 2A is a detail section view showing a magnet within a cavity;

FIG. 2B is a detail view showing an alternative arrangement of magnets used in the apparatus of the present invention in which the magnets are arrayed in a generally circular configuration;

FIG. 3 is an cutaway section showing different anchor point arrangements suitable for use with various embodiments of the present invention;

FIG. 4 is an exploded view a further embodiment of the mounting bracket of the present invention that includes an internal rigid plate;

FIG. 4A is an exploded view of a still further embodiment that includes various layers defining the upper support portion;

FIG. 5 is an elevation view of a clamping unit that can be used with the mounting bracket apparatus of the present invention;

FIG. 5a is an elevation view of a further clamping unit;

FIG. 6 is an elevation view of a still further clamping unit;

FIG. 6a is an elevation view of another clamping unit for use with the mounting bracket apparatus of the present invention;

FIG. 7 is a perspective view of a second embodiment of the invention including a clamping unit; and

FIG. 8 is a section view taken along line 7-7 of FIG. 7 showing the base of the mounting bracket of FIG. 4 including the region housing the magnets;

FIG. 9 is a perspective view of a bracket removal arrangement to permit prising of the bracket from a metallic surface;

FIG. 10 is a view of an alternative clamping unit that relies on straps equipped with hook and look fasteners;

FIG. 11 is an elevation view of another clamping unit comprising a semi-rigid tube of material; and

FIG. 12 is an elevation view of a further clamping unit that includes a pivoting bracket for supporting a structure such as a lamp.

### DESCRIPTION OF THE PREFERRED EMBODIMENTS

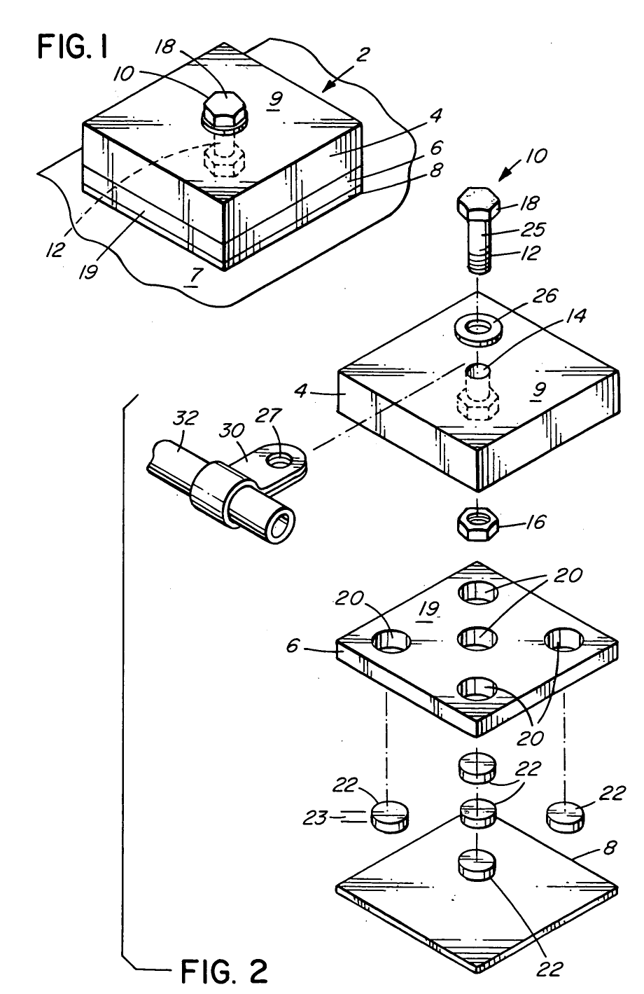

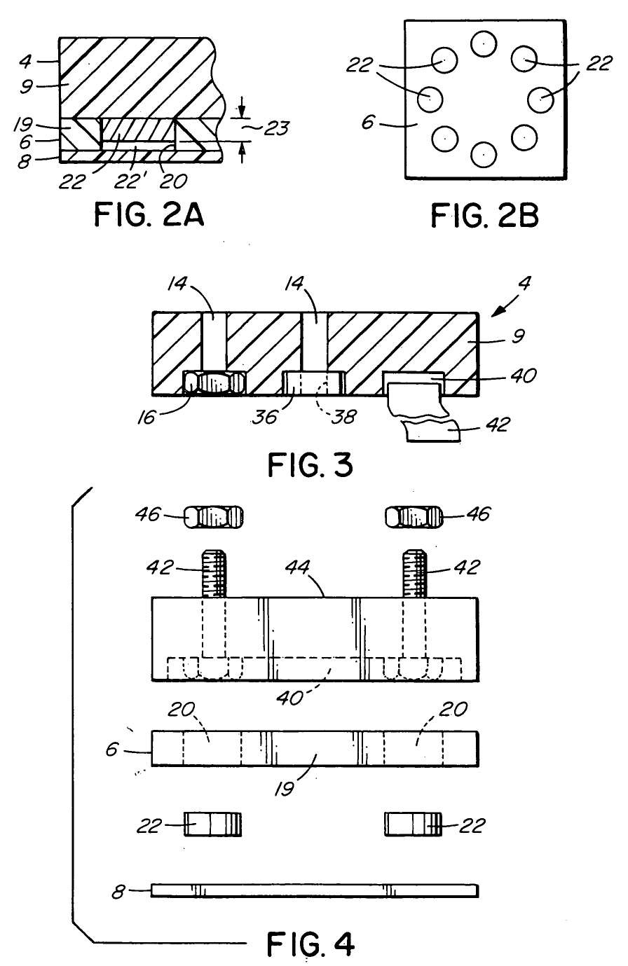

Referring to FIGS. 1 and 2, there is shown a first preferred embodiment of the mounting bracket apparatus 2 of the present invention suitable for mounting an object to a ferromagnetic surface. Mounting bracket 2 comprises an upper support portion 4 adapted to retain the object to be anchored. Below upper support portion 4, a lower magnetic base 6 is provided to connect to a ferromagnetic surface 7. Interposed between magnetic base 6 and the ferromagnetic surface 7 is a friction layer 8 to separate the magnetic base from direct contact with the ferromagnetic surface. Magnetic base 6 acts to releasably retain upper support portion 4 on the ferromagnetic surface while friction layer 8 acts to minimize slippage of the entire assembly.

In the preferred arrangement of FIGS. 1 and 2, upper support portion 4 is preferably formed from a block 9 of elastomeric material such as synthetic rubber, also known as neoprene, of sufficient hardness to maintain its shape. Other suitable materials include plastics of various hardnesses and natural rubbers of various hardnesses. A steel plate, preferably encased in a rustproof coating such as zinc or the like can also be used for upper support portion 4. While a generally parallelepiped block is illustrated in FIGS. 1 and 2, it will be appreciated that support portion 4 can be formed into any shape appropriate for the mounting location of interest. Neoprene is preferred as a material as it is flexible and durable, resisting degradation from sun, ozone and weather, performs well in contact with oil and other chemicals, and remains pliant over a wide range of temperatures. Neoprene is also very tough and displays excellent resistance to damage caused by flexing and twisting.

As best shown in FIG. 2, magnetic base 6 is preferably formed from a layer 19 of material with at least one cavity 20 housing at least one permanent magnet 22. In the illustrated embodiment, there are a plurality of spaced cavities 20 with each cavity holding a single permanent magnet 22. Preferably, layer 19 is formed from a firm, yet compressible material such as neoprene that is mounted to block 9. Preferably, joining of layer 19 to block 9 is accomplished using a suitable adhesive, but other fastening techniques, such as bolting or riveting are possible. If the parts are adhered together, adhesives such as contact cement, ethyl cyanoacrylate based products, epoxy resins or the like can be used. Alternatively, instead of a separate layer 19, magnetic base 6 can be integrated with block 9 by forming cavities 20 at the lower surface of block 9. In either arrangement, magnets 22 are preferably adhered by an adhesive such as epoxy resin to block 9 within cavities 20.

Magnets 22 are preferably ferrite core or neodymium magnets which are small in size, but powerful, and capable of maintaining their magnetic strength. Such magnets are commonly available in a disc or “plug” configuration having a thickness 23. Referring to FIG. 2A which is a detail section view of a cavity with a magnet therein, each cavity 20 is preferably dimensioned and each permanent magnet 22 is selected such that the magnet thickness 23 is less than the depth of the cavity to create a space or air gap 22′ between the lower surface of the magnet and the lower surface of magnetic base 6. This air gap is preferably in the range of about 1/64 inch to about 1/32 inch. While disc shaped magnets are discussed below, a person skilled in the art will appreciate that magnets of other shapes can be used with the present invention.

Friction layer 8 is preferably adhered to the underside of magnetic base 6 over cavities 20 to seal magnets 22 within the cavities. The adhesive used to join magnetic base 6 and friction layer 8 offers the added benefit of sealing the magnets within the cavities of base 6 to minimize corrosion. Friction layer 8 preferably comprises a flexible sheet of material having a high coefficient of friction to minimize slippage of the mounting bracket 2 once it is affixed to a ferromagnetic surface. Friction layer 8 is selected from a material such as soft neoprene, rubber or the like and is sufficiently thin to allow the magnetic force of magnets 22 to hold the entire mounting bracket 2 to ferromagnetic surface 7. Friction layer 8 acts to minimize slippage of the mounting bracket along ferromagnetic surface 7 if the mounting bracket should be exposed to a lateral force below a threshold level. In addition, friction layer 8 provides a non-marring surface that will not scratch or mark ferromagnetic surface 7. If a lateral displacing force above the threshold is encountered, the mounting bracket of the present invention will slide or detach from ferromagnetic surface 7. The strength of the anchoring force holding the mounting bracket to the ferromagnetic surface depends on the type, strength, number and placement of magnets 22. It will be appreciated that different types, strengths, number and arrangements of magnets can be used from those illustrated to achieve a desired magnetic holding force. FIG. 2 shows an arrangement with magnets in four corners surrounding a central magnet. By way of example, FIG. 2B shows an alternative arrangement in which the magnets are arrayed in a generally circular configuration.

When attached to a ferromagnetic surface, the magnets 22 in cavities 20 which are mounted to support portion 4 will tend to compress layer 19 defining magnetic base 6 as the magnets are attracted to the magnetic surface. The compression of layer 19 will tend to shrink airspace 22′ below each magnet which provides a better gripping effect.

As best shown in exploded FIG. 2, the mounting bracket of the present embodiment has an upper support portion 4 that includes at least one anchor point 10 for securing an object directly or for securing an object holding device. In the illustrated embodiment, anchor point 10 is defined by a threaded fastener 12 that extends through an elongate opening 14 formed in block 9. Opening 14 can be threaded correspondingly to receive and retain fastener 12. For even more reliable retention of fastener 12, a nut 16 or other suitable threaded member is embedded in block 9 and aligned with opening 14 to threadably engage and retain an end of threaded fastener 12.

The protruding head 18 of threaded fastener 12 is used to directly engage an object to be anchored. For example, the shaft 25 of fastener 12 is inserted through an opening 27 in a retaining clip or loop 30 attached to the object 32 to be anchored, and the fastener is tightened into opening 18 to hold the object to support portion 4.

Preferably, a washer 26 is also place on fastener shaft 25 to clamp the loop 30 between head 18 of fastener 12 and the washer.

FIG. 3, which is a cross-section through block 9, illustrates additional anchor point arrangements that are useful with the apparatus of the present invention. On the left hand side of the Figure, there is shown an embedded nut 16 having a central opening aligned with opening 14 through body 9 to threadably receive the shaft 25 of fastener 12. In the middle of FIG. 3, there is shown an arrangement comprising an elongate bar 36 (extending out of the page) embedded in body 9 having at least one threaded opening 38 therethrough to receive the shaft of a fastener. This arrangement is best suited for a mounting scheme that involves multiples fasteners extending from body 9 in a line defined by the elongate bar. In a still further arrangement, the anchor point comprises at least one slot 40 extending through block 9. A strap 42 extending through the slot acts as an object holding device which can be looped about the object to be held. The ends of the strap are provided with conventional fasteners (not shown) such as a buckle or a hook and loop arrangement to secure the ends in a closed loop about the object.

FIG. 4 is an exploded view of an alternative embodiment of the mounting bracket of the present invention similar to the embodiment illustrated in FIGS. 1 and 2. Identical parts are labeled with the same reference number. In this embodiment, upper support portion 4 comprises an elastomeric body 9, preferably formed from neoprene, that includes an embedded rigid plate member 40 to strengthen body 9. Rigid plate member 40 is preferably a steel plate housed within a cavity in the neoprene block. In this embodiment, a pair of threaded shafts 42 extend upwardly from plate 40 through body 9 to protrude through the upper surface 44 of body 9 to define a pair of anchor points. Nuts 46 are threadable onto posts 42 to secure a clip or loop in place. Magnetic base 6 with magnets 22 housed in cavities 20 and friction layer 8 are positioned below block 9 as in the first embodiment.

A further embodiment of the present invention is shown in FIG. 4a wherein upper support portion 4 is formed from multiple layers for variable strength and rigidity. For example, support portion 4 can be formed from an upper layer 200 of metal, an elastomeric material such plastic or rubber, including neoprene, and a lower layer 202 comprising a rigid plate member 40 that is inserted within a corresponding opening 204 formed in an elastomeric material layer 205 to surround the rigid plate member. Lower layer 202 of upper support portion 4 is sandwiched between upper layer 200 and magnetic base 6 to completely enclose rigid plate member 40. Glue is preferably used to bond the various layers together which serves to seal rigid plate 40 within the interior of the apparatus thereby minimizing the potential for corrosion when rigid plate 40 is formed from steel. Upper layer 200 is formed with openings 14 that align with internally threaded holes formed in rigid plate 40. As in previous embodiments, magnetic base 6 for housing magnets 22 and friction layer 8 are preferably formed from neoprene and adhered to the lower surface of support portion 4. Other attachment schemes such as riveting or bolting are also possible.

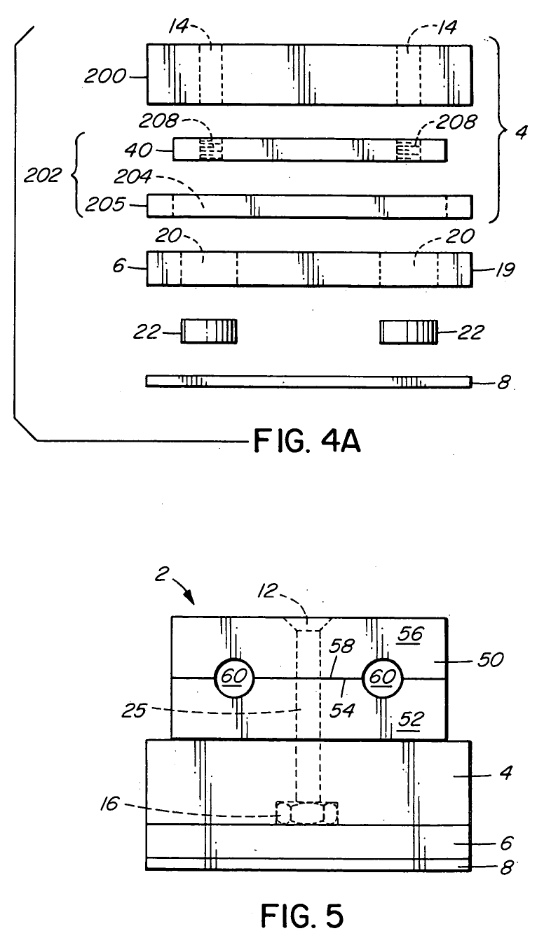

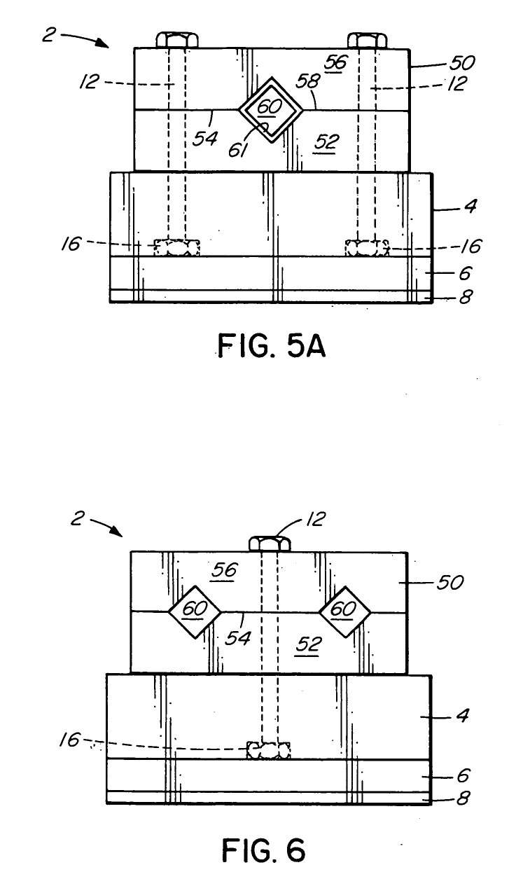

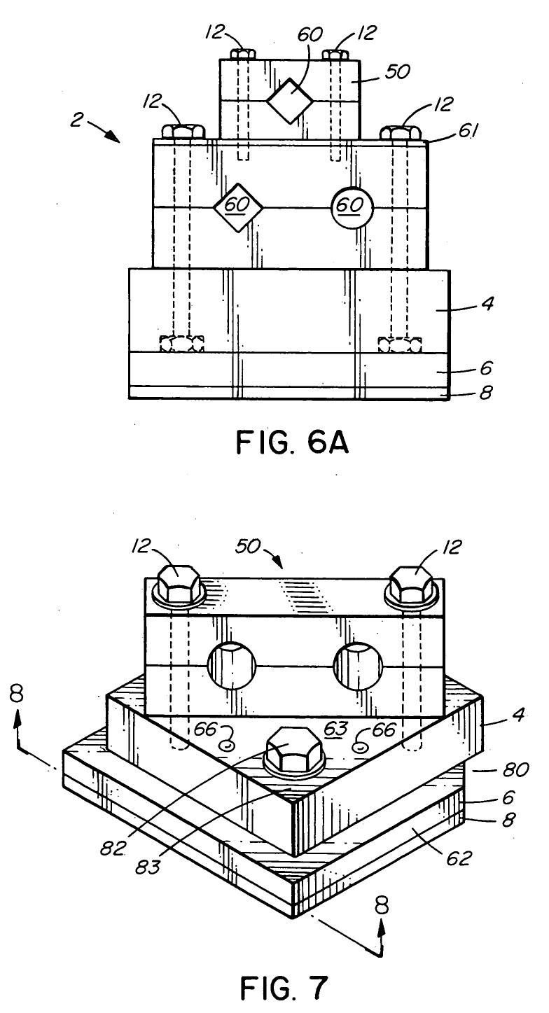

FIGS. 5, 5a, 6 and 6a show an embodiment of the mounting block 2 of the present invention fitted with an object retaining device comprising a clamping unit 50. Each clamping unit 50 comprises a first clamp member 52 anchored adjacent the support portion 4 having a first clamping surface 54 and a second clamp member 56 having a second clamping surface 58 releasably engageable with the first clamping surface to hold and grip an object therebetween. Preferably, first and second clamping surfaces 54, 58 are formed with at least one set of opposed, alignable channels 60 that co-operate to define an opening through the clamp members 52,56 to accommodate a tubular object. Clamping units 50 find particular application in holding and organizing hydraulic, pneumatic or coolant hoses used with heavy machinery or in holding cabling.

FIG. 5 shows a clamping unit 50 that is mounted to support port 4 by a single, central threaded fastener 12 shown by dashed lines extending through the first and second clamping members 52,56 into embedded nut 16. In this case, the head of fastener 12 is countersunk into the top of clamping member 56 so that the fastener does not protrude from the top of the clamping unit. Single fastener 12 acts both to anchor the clamping unit 50 to support portion 4 and to hold the clamping member 52, 56 together to clamp hoses fed through aligned channels 60. In this embodiment of FIG. 5, channels 60 define a generally cylindrical opening.

FIG. 5a shows a clamping unit 50 that relies on a pair of threaded fasteners 12 on either side of central aligned channels 60 to locate the clamping unit on support portion 4 and to exert a clamping force. In this arrangement, channels 60 define diamond shaped openings for gripping hoses or conduits within the channels.

FIG. 6 shows a further example of a clamping unit 50 that relies on a single threaded fastener 12 extending between two diamond shaped channels 60. Single fastener 12 acts both to anchor the clamping unit 50 to support portion 4 and to hold the clamping member 52, 56 together to clamp hoses fed through aligned channels 60.

FIG. 6a shows a clamping unit 50 similar to that illustrated in FIG. 5a. In this embodiment, a main clamping unit 50 includes a pair of different channels 60 with one channel being round and the other being diamond shaped, for example. Atop main clamping unit 50 is an auxiliary clamping unit 50′ that is mounted to the main unit via fasteners 12. A steel plate 61 is optional provided between main clamping unit 50 and auxiliary unit 50′.

In the clamping units of FIGS. 5a, 6, and 6a, which disclose channels 60 having a diamond shaped configuration, first and second clamping members 52, 56 are preferably made from an elastomeric material that is readily deformable, such as neoprene of a lesser hardness than used in block 9, for example. Such an arrangement permits ready deformation of walls of the channel to accommodate objects such as hoses or lines of a range of dimensions. The softer material also tends to exert a better grip on the object within the channel for more reliable holding. As an alternative to forming the entire clamping member from a softer elastomeric material, it is also possible to fit liners 61 of a soft elastomeric material into channels 60 as illustrated in FIG. 5a.

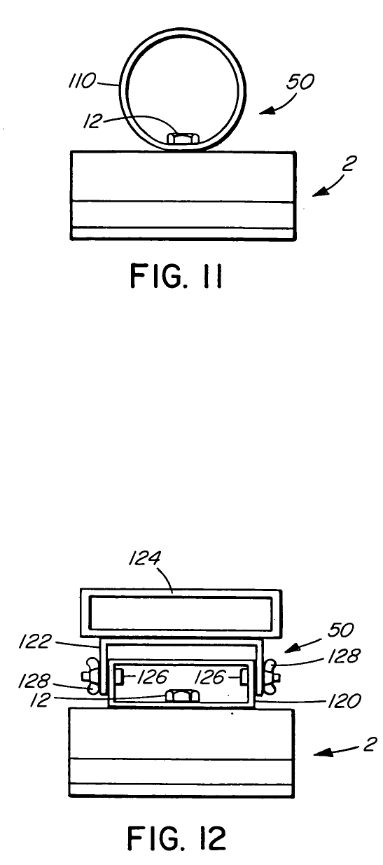

FIGS. 10 to 13 illustrate still further examples of clamping units 50 attached to the mounting bracket apparatus 2 of the present invention. FIG. 10 shows a clamping unit comprising a pair of straps 100,102 each having a first end 104 attached to mounting bracket apparatus 2 by a fastener 12 and a second end 106 formed with complementary hook and look fastener strips 107, 108 to permit forming of a closed loop of adjustable dimensions. Other fasteners such as snaps, buckles or buttons can be used to join the second ends of the straps together. FIG. 11 illustrates an arrangement that relies on a clamping unit comprising an elastomeric tubular member 110 attached to mounting bracket apparatus 2 by a single fastener 12. Tube 110 is selected to retain a hose or other cylindrical object (not shown). FIG. 12 shows a clamping unit 50 that includes a rigid base 120 mounted to mounting bracket apparatus 2 by fastener 12. Base 120 pivotally supports a platform 122 to which an article 124 is attached. A pair of fasteners 126 which threadably receive wing nuts 128 pivotally interconnect platform 122 and rigid base 120 such that tightening of the wing nuts locks the relative positions of the platform and base. Article 124 can be any desired article that requires reliable mounting to a metallic surface. For example, article 124 can be a lamp.

In all of the above clamping unit arrangements, the first and second clamping members are preferably formed from hard neoprene which has excellent non-slip gripping properties. Hoses and pipes of different dimensions are holdable in the same size of diamond opening. No sliding and minimal wear of the hoses and pipes results. At the same time, neoprene offers good vibration absorption properties to decrease wear on the object being retained in channels 60. Many different clamping unit configurations are possible and will be apparent to a person skilled in the art. The clamping unit of the present invention is not limited to the specific embodiments illustrated in the Figures.

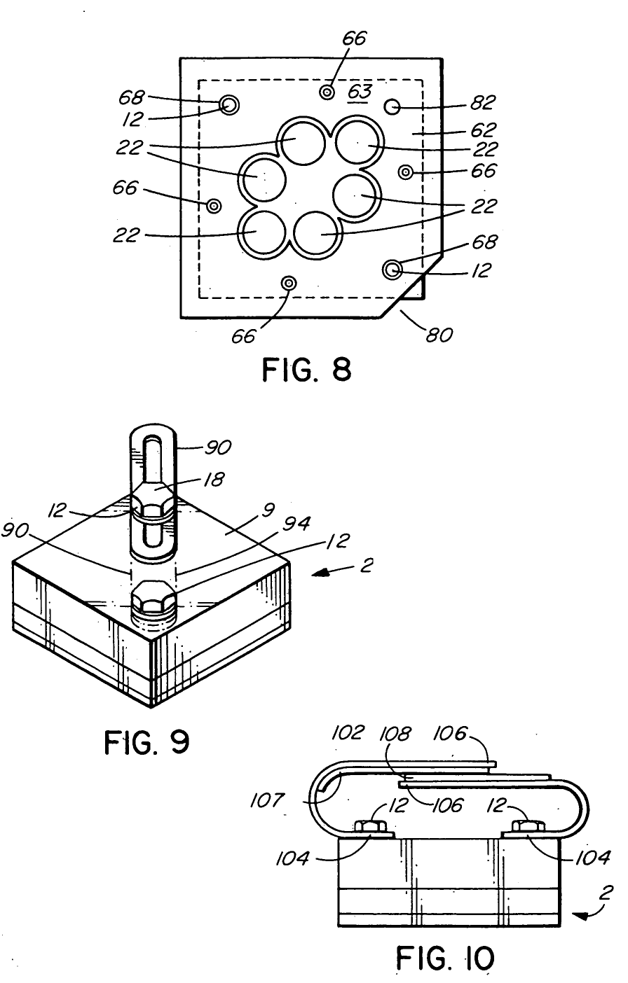

FIGS. 7 and 8 illustrate a further embodiment of the mounting bracket of the present invention. In this arrangement, support portion 4 comprises a rigid metal plate 63 and magnetic base 6 comprises a layer 62 of substantially rigid material such as neoprene of an appropriate hardness. Metal plate 63 is preferably formed from a corrosion resistant metal. Rigid neoprene layer 62 is attached to metal plate 63 by suitable means such as rivet fasteners 66 or adhesive. A friction layer 8 in the form of a flexible neoprene sheet is adhered to the underside of layer 62. As best shown in FIG. 8, which is a section view taken along line 7-7 of FIG. 7 to show the base of the mounting bracket with friction layer 8 removed, rigid neoprene layer 62 is formed with a single large cavity housing a plurality of permanent disc shaped magnets 22 in a closed loop configuration. A clamping unit 50 of the general type described above in reference to FIGS. 5-6 is attached to the upper surface of metal plate 63 by fasteners 12 which are threadably received in threaded openings 68 extending through plate 63. The mounting bracket of FIGS. 7 and 8 is a compact, low profile version.

The mounting bracket of FIGS. 7 and 8 also discloses a number of exemplary bracket removal features that find application in all embodiments of the present invention. Once a mounting bracket is attached to a ferromagnetic surface, bracket removal features are provided to facilitate release of the bracket. As best shown in FIG. 8, a corner 80 of magnetic base 6 is removed to provide a location to insert a tool to prise up the edge of the mounting bracket. Alternatively, bolt 82 in corner 83 of plate 60 provides a further removal tool. Bolt 82 is received in a threaded opening in plate 60. Tightening bolt 82 into the opening will tend to lift corner 83 of the plate from the ferromagnetic surface thereby weakening the magnetic attraction between the magnets and the surface to an extent sufficient to remove the mounting bracket.

FIG. 9 shows an alternative bracket removal feature comprising a slotted bar 90 that is adapted to fit underneath head 18 of a fastener 12. Bar 90 can be positioned to project outwardly from block 9 by sliding the bar beneath head 18. When protruding, bar 90 provides a lever to assist in prising up mounting bracket apparatus 2 from a metallic surface. When not in use, bar 90 can be fitted and stowed beneath one or more fasteners 12 as illustrated by dashed lines 94.

While the mounting bracket apparatus of the present invention has been described primarily with respect to anchoring hoses, lines or cables, it will be appreciated that the mounting bracket has uses in other environments where an article is required to be mounted to a ferromagnetic surface. For example, the mounting bracket of the present invention is also useful for mounting equipment such as fire extinguishers or other safety equipment to a mounting location in a vehicle. Vehicle emergency lights or brake lights attached to the mounting bracket of the present invention are readily installable on the exterior of a vehicle at any desired location and removable without damaging the vehicle finish.

Although the present invention has been described in some detail by way of example for purposes of clarity and understanding, it will be apparent that certain changes and modifications may be practised within the scope of the appended claims.

1. An apparatus for mounting an object to a ferromagnetic surface comprising:
(a) an upper support portion adapted to retain the object;
(b) a lower magnetic base to the support portion, the base being attractable to the ferromagnetic surface; and
(c) a friction layer below the magnetic base to separate the magnetic base from direct contact with the ferromagnetic surface whereby the magnetic base acts to releasably retain the support portion on the ferromagnetic surface and the friction layer acts to prevent slippage.

2. The apparatus of claim 1 wherein the magnetic base is formed with at least one cavity housing at least one permanent magnet.

3. The apparatus of claim 2 in which the at least one cavity comprises a plurality of spaced cavities with each cavity holding one of the permanent magnets.

4. The apparatus of claim 2 in which the at least one cavity and the at least one permanent magnet are dimensioned such that a space exists between the magnet and the friction layer.

5. The apparatus of claim 2 in which the friction layer acts to seal the at least one permanent magnet within the at least one cavity.

6. The apparatus of claim 1 in which the magnetic base comprises a compressible, elastomeric layer attached to the upper support portion and adapted to house at least one permanent magnet.

7. The apparatus of claim 6 in which the elastomeric layer is formed from a material selected from the group comprising rubber, plastic and neoprene.

8. The apparatus of claim 2 in which the friction layer is a flexible sheet of elastomeric material interposed between the at least one permanent magnet and the ferromagnetic surface.

9. The apparatus of claim 8 in which the elastomeric material is formed from neoprene.

10. The apparatus of claim 1 in which the support portion comprises a block of elastomeric material.

11. The apparatus of claim 10 in which the magnetic base comprises a layer of compressible neoprene adhered to the support portion, the magnetic base being formed with at least one cavity housing at least one permanent magnet.

12. The apparatus of claim 10 in which the support portion includes a metal plate received within a cavity in the block of elastomeric material.

13. The apparatus of claim 1 in which the support portion comprises a metal plate.

14. The apparatus of claim 13 in which the magnetic base comprises a layer of rigid neoprene riveted to the metal plate, the rigid neoprene being formed with at least one cavity housing at least one permanent magnet.

15. The apparatus of claim 14 in which the plate is formed from a corrosion resistant metal.

16. The apparatus of claim 1 in which the support portion includes at least one anchor point for securing an object holding device.

17. The apparatus of claim 16 in which each anchor point comprises a threaded opening formed in the support portion.

18. The apparatus of claim 17 in which the threaded opening comprises a nut embedded in the support portion.

19. The apparatus of claim 17 including a bar embedded in the support portion formed with the at least one threaded opening extending therethrough.

20. The apparatus of claim 17 in which the object holding device comprises a threaded shaft engageable in the threaded opening.

21. The apparatus of claim 16 in which the anchor point comprises a threaded shaft extending from the support portion.

22. The apparatus of claim 21 in which the object holding device comprises a threaded nut engageable on the threaded shaft.

23. The apparatus of claim 16 in which the anchor point comprises at least one slot formed in the support portion.

24. The apparatus of claim 23 in which the object holding device comprises a strap extending through the slot.

25. The apparatus of claim 16 in which object retaining device comprises a clamping unit.

26. The apparatus of claim 25 in which the clamping unit comprises a first clamp member anchored adjacent the support portion having a first clamping surface and an second clamp member having a second clamping surface releasably engageable with the first clamping surface to hold and grip the object therebetween.

27. The apparatus of claim 26 in which the first and second clamping surfaces are formed with at least one set of opposed, alignable channels, the channels co-operating to define an opening through the clamp members to accommodate a substantially tubular object.

28. The apparatus of claim 27 in which the channels define a generally cylindrical opening.

29. The apparatus of claim 27 in which the channels define a generally diamond shaped opening.

30. The apparatus of claim 26 in which the first and second clamping members are clamped together by fasteners that engage with the at least one anchor point of the support portion.

31. The apparatus of claim 16 in which the object holding device comprises an elastomeric tubular element.

32. The apparatus of claims 16 in which the object holding device comprises a pair of straps, the straps having first ends secured to the support portion by the at least one anchor point and second ends formed with complementary fasteners to releasably join the second strap ends together.

33. The apparatus of claim 16 in which the object holding device comprises a bracket arrangement having a base anchored to the support portion and a platform portion pivotal with respect to the base.

34. The apparatus of claim 1 in which the support portion includes an object retaining device to hold an object in a fixed position with respect to the support portion.

35. The apparatus of claim 1 including a removal system to facilitate removal of the mounting bracket from a ferromagnetic surface.

36. An apparatus for attaching an object to a ferromagnetic surface comprising:
(a) a friction surface adapted to contact the ferromagnetic surface;
(b) a compressible magnetic base adapted to be secured to the ferromagnetic surface at the friction surface; and
(c) an object holding device extending from the magnetic base.

37. The apparatus of claim 36 in which the compressible magnetic base comprises a layer of elastomeric material housing at least one magnet.
